(19) United States
(12) Patent Application Publication
(10) Pub. No.: US 2025/0282436 A1
(43) Pub. Date: Sep. 11, 2025

(54) MOTORCYCLE WITH REMOVAL SIDE BAGS WITH FASTENING

(71) Applicant: PIAGGIO & C. S.P.A, Pontedera (IT)

(72) Inventors: Alberto Brai, Pontedera (IT); Francesco Marchetta, Pontedera (IT)

(21) Appl. No.: 18/858,126

(22) PCT Filed: May 9, 2023
(86) PCT No.: PCT/IB2023/054781

§ 371 Date: Oct. 18, 2024

(30) Foreign Application Priority Data
May 9, 2022 (IT) 102022000009497

(51) Int. Cl. B62J 9/27; B62J 9/23

(52) U.S. Cl. CPC B62J 9/27; B62J 9/23

(57) ABSTRACT

The invention relates to a motor vehicle comprising a frame, to a saddle that is movable relative to the frame, and to at least one removable bag. The removable bag comprises at least one hook-like element insertable into a corresponding opening of the frame and adapted to cooperate with a portion of the saddle to connect said bag stably to said frame.

### CROSS-REFERENCE TO RELATED APPLICATIONS

This application claims priority to PCT International Application No. PCT/IB2023/054781 filed on May 9, 2023, which applications claims priority to Italian Patent Application No. 102022000009497 filed on May 9, 2022, the entire disclosures of which are expressly incorporated herein by reference.

### STATEMENT RE: FEDERALLY SPONSORED RESEARCH/DEVELOPMENT

Not Applicable

### BACKGROUND

### Field of the Invention

The present invention relates to the technical field of motorcycles. In further detail, the present invention relates to the technical field of fasteners for removable bags for motorcycles, in particular motorcycles.

### Prior Art

In particular, motorcycles are generally provided with removable bags applied to the side of the frame. Bags are typically two, applied to both sides of the frame although single-bag configurations do exist.

In the solutions of the prior art, such bags are typically attached in a removable manner to the frame by means of key-locking mechanisms to prevent their undue removal. FIG. 1 shows an example which takes advantage of a fastening sub-frame 13 integral to the motorcycle.

Although they perform well their task, these solutions are nevertheless not optimal. Indeed, the addition of lock mechanisms causes increased costs in terms of components and maintenance but also implies some inconvenience for the user, who is forced to carry an additional key.

On the other hand, release mechanisms which can be locked/unlocked by means of a key or buttons activated by electronic transponder devices recognizing a security code carried by the user already exist in motorcycles. For example, one may consider the steering lock or the locks of opening saddles. Therefore, it would be advantageous to be able to exploit these mechanisms also for fastening bags.

It is known from document U.S. Pat. No. 5,655,694A that a bag can be connected to the saddle of a vehicle. Furthermore, it is also known from document DE29706896 that it is possible to secure a bag to the vehicle by means of anchoring systems present on the frame and prevent access to the anchoring means by arranging the saddle of the vehicle in the closed position.

Therefore, it is the object of the present invention to provide a motorcycle equipped with a removable bag fastening mechanism which is simple, inexpensive, and easy to use, and which does not require the use of key safety devices in addition to those normally found in motorcycle setup of known types.

### SUMMARY OF THE INVENTION

The invention achieves the object with a motor vehicle comprising a frame, a saddle, movable relative to the frame, and at least one removable bag. The saddle, typically shaped to accommodate the driver and the passenger or only the passenger, is connected or connectable to the frame and configured to assume an open position, in which the saddle is at least partially detached from the frame, and a closed position, in which the saddle is entirely constrained to the frame. The removable bag has the feature of comprising at least one hook-like element insertable into a corresponding opening of the frame and adapted to cooperate with a portion of the saddle to stably connect the bag to said frame when the saddle is in the closing position.

In an embodiment, the portion of the saddle which cooperates with the hook-like element comprises a protuberance, which protrudes below the saddle. When the saddle is in the closed position, the protuberance occludes a first part of the opening of the frame leaving a second part of the opening free, while, when the saddle is in the open position, said opening is entirely free.

The hook-like element may advantageously comprise a stem and an end portion having a width greater than that of the stem, with the stem being shaped to at least partially fill said first part of the opening when the saddle is in the closed position, while the end portion of the hook-like element is shaped so as not to pass through said first part of the opening when the saddle is in closed position.

There are typically two openings of the frame, a first opening, which faces the right side of the motor vehicle, and a second opening, which faces the left side of the vehicle so that a bag can be mounted on one or both sides of the motor vehicle.

Additional attachments and/or supports of the at least one removable bag to the motor vehicle, e.g., at a passenger foot support bracket, can be provided to increase the strength of the fastening.

Further features and improvements are the subject of the sub-claims.

### BRIEF DESCRIPTION OF THE FIGURES

Further features and advantages of the invention will be apparent from the reading of the following detailed description, provided by way of non-limiting example, with the aid of the figures shown on the accompanying figures, in which:

FIG. 1 shows a perspective view of a case fixed to a sub-frame of a motorcycle by means of hooks with securing locks according to the prior art.

FIG. 2 shows a perspective view of a frame of a motorcycle (FIG. 2a) which has attachment seats for a bag (FIG. 2b) according to a second embodiment of the invention.

FIG. 3 shows a perspective view of a motorcycle with a bag mounted and saddle locked in place.

FIG. 4 shows the same view as the preceding figure with the saddle unlocked for opening.

FIG. 5 shows a side section view (FIG. 5a) and front (FIG. 5b) of the passenger saddle in the unlocked position.

FIGS. 6-8 show the detail of the attachment of the bag to the motorcycle frame in three operating positions: bag with attachments in a locking position and saddle in an open position (FIG. 6), bag with attachments translated for disengagement from the seat (FIG. 7), bag of the extraction (FIG. 8).

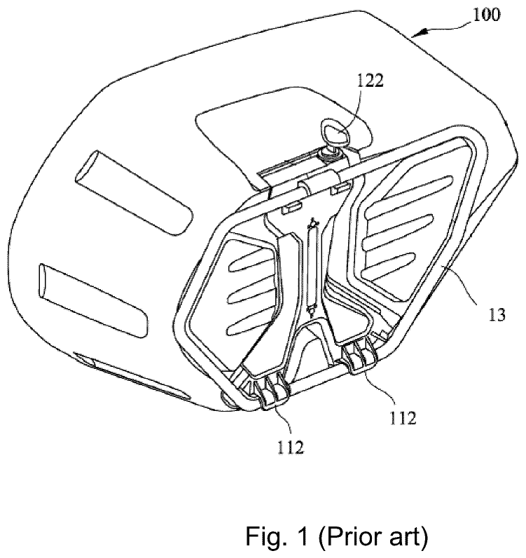

The following description of exemplary embodiments relates to the accompanying drawings. The same reference numbers in the various drawings identify the same elements or similar elements. The following detailed description does not limit the invention. The scope of the invention is defined by the appended claims.

### DETAILED DESCRIPTION OF THE INVENTION

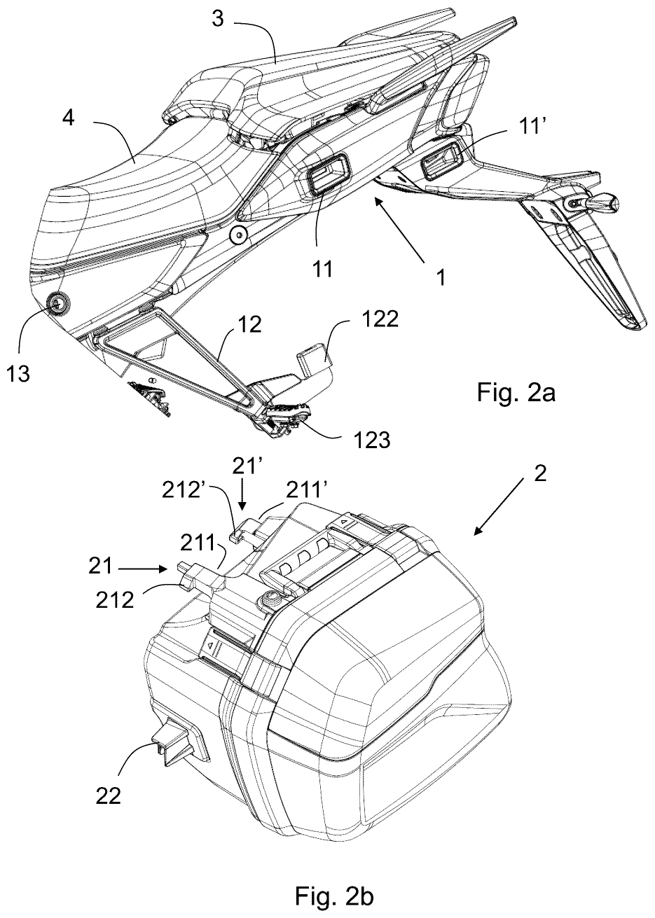

With reference to FIG. 2, the frame 1 of a motorcycle according to a first embodiment of the invention comprises seats or openings 11, 11′ for attaching a bag 2. Said openings 11,11′ are made in a portion of the frame 1 or in an element integrally connected to the frame 1.

In the specific example shown in the figure, there are three seats represented by two openings on the side of the motorcycle 11, 11′ and by a tab 122 carried by the bracket 12 supporting the passenger pedal 123. The openings 11, 11′ are shaped and adapted to allow the bayonet coupling of corresponding hook-like protuberances 21, 21′ provided on one side of the bag 2 while the tab on the supporting bracket 12 of the pedal 123 is adapted to interlock, from bottom upwards, in a side guide 22 of the bag 2 having an inverted U-shaped conformation.

Different configurations may exist, e.g., free from the attachment with the crank support bracket or with only one opening, or with multiple openings. There may also be further coupling protuberances with corresponding bag seats located elsewhere on the frame, e.g., such as on the rear end or on specially provided brackets to strengthen the bag fastening. It is also possible to provide for the use of an attachment sub-frame as the solution according to the prior art.

Now, we will see in detail the mechanism for attaching the bag to the motorcycle frame by means of the protuberance/opening attachment. This is particularly advantageous because it makes it possible to take advantage of the locking device on the saddle, e.g., such as the passenger saddle, in order to lock the bag in place, mounted on the motorcycle without having to use additional locks.

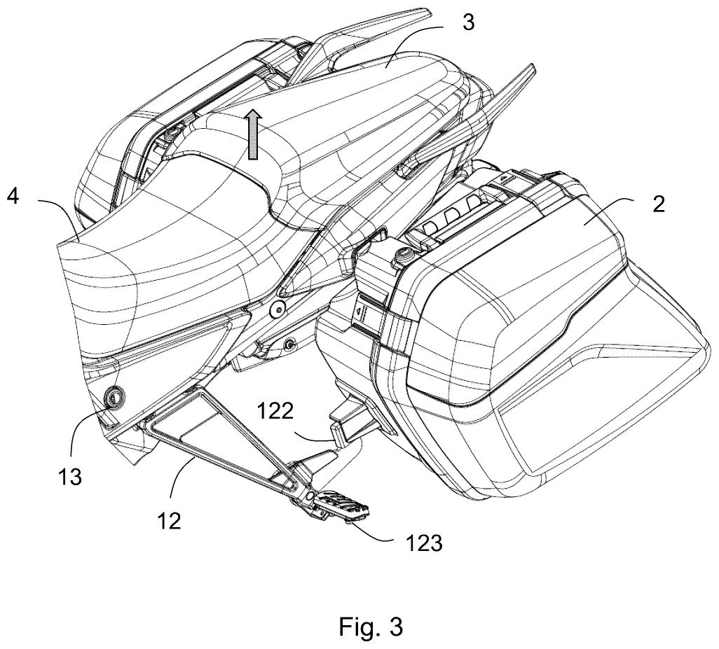

FIG. 3 shows a pair of bags mounted on a motorcycle according to an embodiment of the invention. In this case, we have a motorcycle with an opening passenger saddle 3 so that the bag locking mechanism is associated with the saddle. Obviously, the bag-locking mechanism may be associated with the driver's saddle 4 or a single opening saddle shaped to accommodate both driver and passenger as a function of the type of setup.

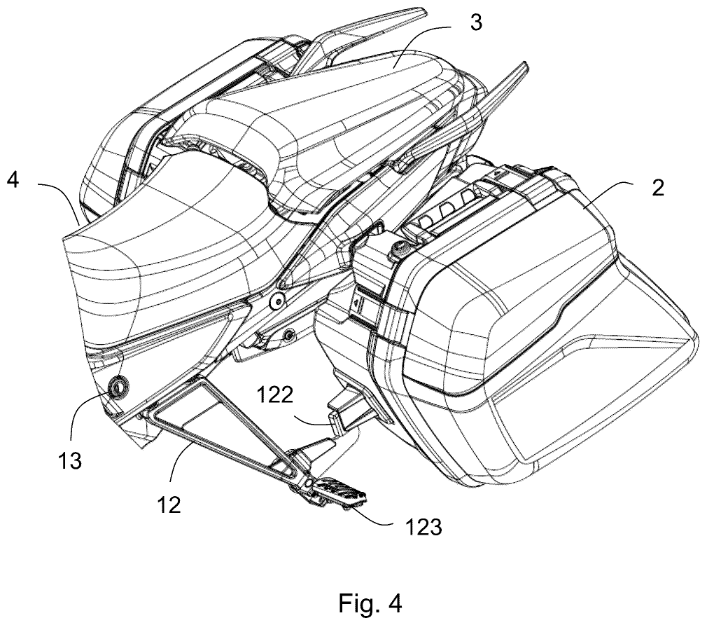

By acting on the lock 13, the passenger saddle 2 releases and moves upward as shown by the arrow in FIG. 3. FIG. 4 shows the same configuration as FIG. 3 with the saddle unlocked.

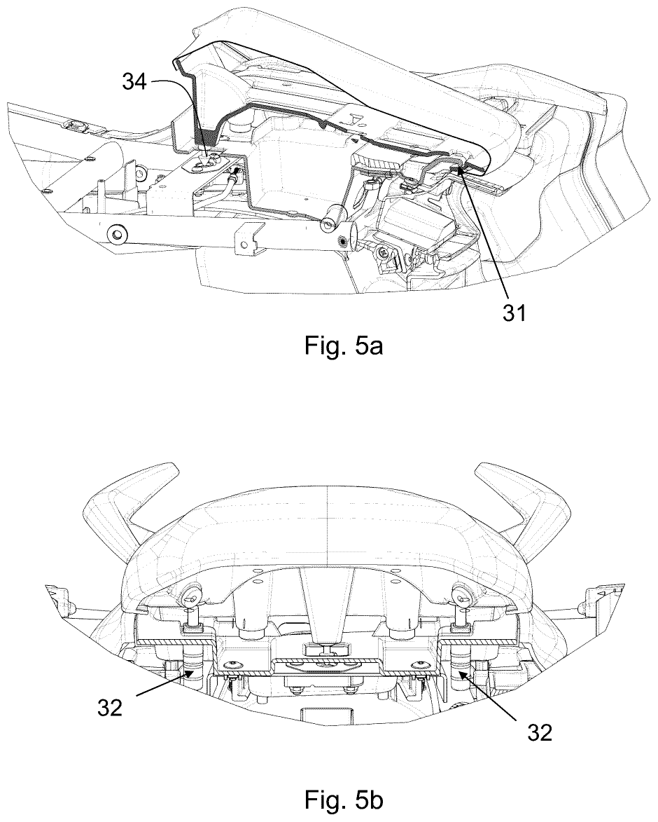

As can be seen from observing FIG. 5, the passenger's saddle 3 is hinged on the back at the recess 31 and has on the front a pair of spring-loaded buttons 32 which raise the saddle upward after the unlocking operated by the lock 13. The saddle 3 further comprises a tooth 34 designed to cooperate with the lock mechanism 13 to lock the saddle 3 to the vehicle.

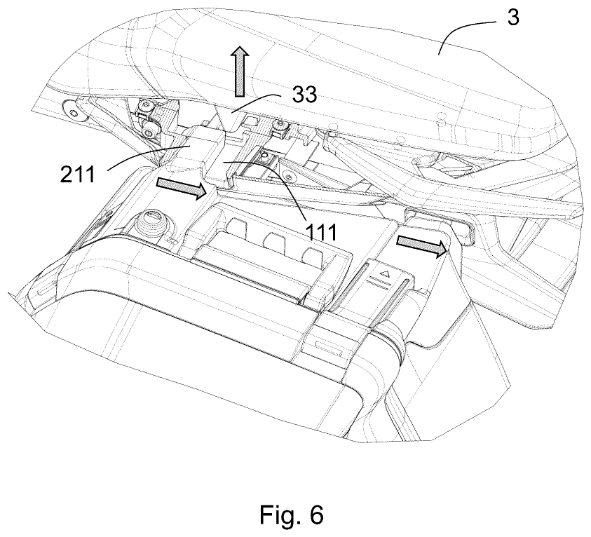

As shown in FIG. 6, the saddle has a pair of protuberances 33, also named portions, arranged on opposite sides at the sides of the motorcycle frame. A single protuberance 33 may also be present in single-bag setups. Each protuberance 33 is provided to engage part of the opening 11 so as to interfere with the hook-like element 21 of the bag. Although it is not visible in the figures, on the right side of the motorcycle, there are additional openings 11,11′ adapted to receive corresponding hook-like elements 21,21′. Furthermore, a further protrusion 33 of the saddle 3 is configured to partially engage the opening 11 so as to interfere with the hook-like element 21 of the right-hand removable bag 2. Substantially, the mechanism of the present invention can be used on both sides of the motorcycle.

It is further understood that the opening partially engaged by the protuberance 33 may be the rear protuberance 11′, rather than the front protuberance 11, although this is not shown in the figures.

For this purpose, the openings 11, 11′ have a first transverse stretch 111 followed by a longitudinal section 112, so as to form an L-shaped conformed space. In contrast, the elements 21, 21′ comprise a stem 211 and an end portion 212 having a width greater than that of the stem 211 to form a hook-shaped element.

When the saddle 2 is closed, the protuberance 33 partially occludes the first stretch of the opening 11 so that the stem 211 cannot move longitudinally as shown in FIG. 6.

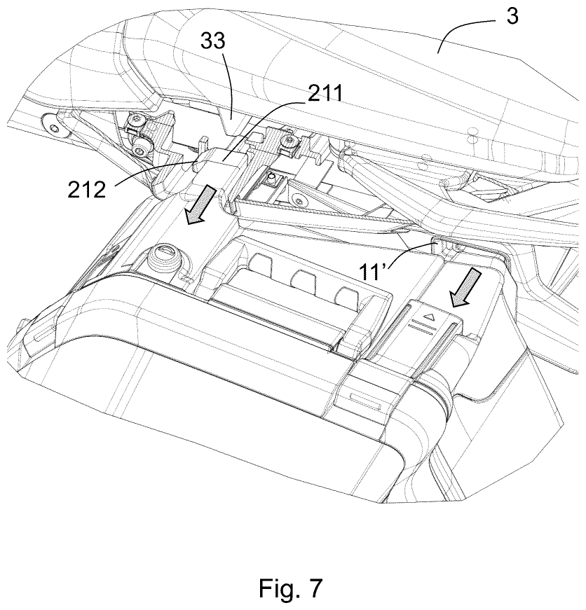

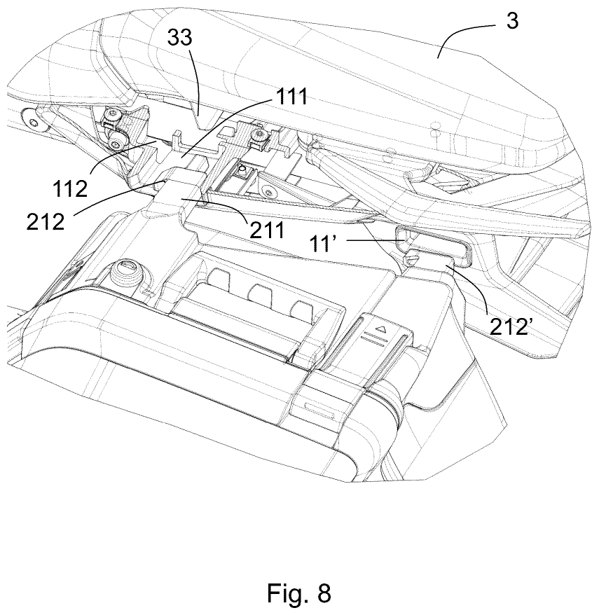

When the saddle opens, the protuberance 33 releases the first stretch of the opening 11 so that the stem 211 can translate in the direction of the longitudinal axis of the motorcycle and be pulled out of the opening 11, as shown in FIG. 7. Indeed, the stem 211 is also free to move in the transverse direction and thus to exit the opening 11, as shown in FIGS. 7 and 8 and, therefore, to allow the bag to be unhooked from the motorcycle frame.

As anticipated, there may be configurations in which there are two or more protuberances, which engage corresponding openings provided on the same side of the frame or on both sides of the frame to ensure greater strength of the locking mechanism.

When the hook-like element 21 is locked by the protuberance 33 of the saddle 3, the stem 211 abuts with the transverse stretch of the opening 11, while the end portion 212 abuts with the longitudinal stretch 112 of the opening 11. Substantially, the backward movement of the hook-like element 11 is prevented, and the bag 3 remains firmly constrained to the vehicle frame 1 until the saddle 3 is raised or removed.

Since the hook-like element 21 maintains this locked position, also the other hook-like element 21′ is interlocked in the corresponding opening 11′, although there is no corresponding portion of the saddle 3 to hold it in this position.

Once the opening 11 has been freed from the protuberance 33 of the saddle 3, both hook-like elements 21 and 21′ can thus be disengaged and pulled out of the corresponding openings 11,11′.

1. A vehicle comprising a frame, a saddle movable relative to the frame, and at least one removable bag, wherein said removable bag comprises at least one hook-like element insertable into a corresponding opening of the frame and adapted to cooperate with a portion of the saddle to stably connect said bag to said frame.

2. The vehicle of claim 1, wherein said saddle portion is a protuberance that protrudes underneath the saddle.

3. The vehicle of claim 1, wherein the saddle is connected or connectable to the frame and configured to assume an open position, in which the saddle is at least partially detached from the frame, and a closed position, in which the saddle is entirely constrained to the frame.

4. The vehicle of claim 1, wherein, when the saddle is in the closed position, said protuberance occludes a first part of the opening of the frame leaving a second part of the opening free, and, when the saddle is in the open position, said opening is entirely free.

5. The vehicle of claim 1, wherein said hook-like element comprises a stem and an end portion having a width greater than the width of the stem.

6. The vehicle of claim 4, wherein said stem is shaped to at least partially fill said first part of the opening when the saddle is in the closed position.

7. The vehicle of claim 6, wherein said end portion of the hook-like element is shaped so as not to pass through said first part of the opening when the saddle is in the closed position.

8. The vehicle of claim 1, wherein there are two openings, a first opening that faces the right side of the vehicle, and a second opening that faces the left side of the vehicle.

9. The vehicle of claim 1, comprising further attachments and/or supports of the at least one removable bag to the vehicle.

10. The vehicle of claim 9, wherein at least one of the further attachments is provided on a support bracket of a passenger's foot.

11. The vehicle of claim 1, wherein said saddle is a saddle shaped to accommodate both the driver and the passenger or a saddle shaped to accommodate only the passenger.
